(19) United States
(12) Patent Application Publication
(10) Pub. No.: US 2015/0278355 A1
(43) Pub. Date: Oct. 1, 2015

(54) TEMPORAL CONTEXT AWARE QUERY ENTITY INTENT

(71) Applicant: MICROSOFT CORPORATION, Redmond, WA (US)

(72) Inventors: SAEED HASSANPOUR, San Francisco, CA (US); JIE CAI, Campbell, CA (US); HYUN-JU SEO, Los Gatos, CA (US); CIYA LIAO, Fremont, CA (US); JINGWEN LU, San Jose, CA (US); ANDREI PETER MAKHANOV, San Jose, CA (US); DAE HO BAEK, Dublin, CA (US)

(73) Assignee: MICROSOFT CORPORATION, Redmond, WA (US)

(21) Appl. No.: 14/229,145

(22) Filed: Mar. 28, 2014

(51) Int. Cl. G06F 17/30

(52) U.S. Cl. CPC G06F 17/30864

(57) ABSTRACT

Systems, methods, and computer-readable storage media for detecting shifts in intent for search queries are provided. The system includes databases and servers. The databases store search logs and entity mappings. The servers merge the entity mappings with search logs, identify shifts in intent for recurring queries in the search log, identify intents for new queries in the search log, and updates mappings between an entity and a query based on the shifted intents. The server may provide client devices that display a search box where queries are entered. The search box may include an autosuggest area that is updated to include spiking entities or spiking queries.

### BACKGROUND

Conventionally, query intent is observed from analysis of search logs having click-through information. The conventional search logs are not very responsive to new queries or spiking queries. The search engine may return results that a user is not interested in especially when a term's meaning shifts or is augmented. One example would be SURFACE™ tablet, a product produced by Microsoft Corporation. The term surface as processed (before the tablet was released) by a search engine would return table tops. After SURFACE™ tablet was introduced, the search logs took a while to determine that a user's intent for surface was changed to SURFACE™ tablet from table top.

The conventional search engines are used to locate a variety of types of information (e.g., music, documents, presentations, people, companies, products, etc.). While returning lists of links to relevant documents is now a familiar format, it is not necessarily a convenient format and the listing may not include the items of interest that have not been indexed in the search system. To find a particular piece of information, the user typically must click through a link to review the corresponding document. The user may have to repeat this process multiple times if the desired information is not located in the first document accessed by the user or the current version index available to the search engine. Accordingly, as illustrated above, out-of-date indices or logs fail to provide the coverage needed to detect spiking or trending queries.

For a small subset of queries, on the other hand, the search engine may provide a listing with the item of interest in the index of the search system. For instance, the item may be popular as measured from appearances in the search logs. The item may be assigned popularity rankings based on the number of times the item appears in the search logs. In turn, a trend in an item's popularity rank may be calculated by the search engine. An entity's popularity rank and trend in popularity rank may be presented in a graph or in a list provided to a searcher. The trend in popularity, however, is a lagging measure that is unable to consistently identify trending or spiking queries.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the invention relate to systems, methods, and computer-readable storage media for, among other things, detecting intent shifts for queries. A server is configured to process existing query to entities mappings, update the query to entities mapping, and rerank the query to entity mappings based on temporal signals. An existing query may have a new entity intent caused by temporal events, e.g., breaking news. In one embodiment, a query may have new entity intent within one or more events in a series of recurring events caused by seasonal changes. Additionally, the server may identify new queries with new entity intents.

In other embodiments, the server is configured to determine whether a query is trending or spiking. In turn, the server confirms a mapping between an entity represented by the query and uniform resource identifiers (URIs) based on query search results accessed by a client device. If the query is identified as trending, the updated mapping between query and entities are stored. Alternatively, when a query is identified as spiking, it is included in an autosuggest area provided by the search engine in response to search terms entered at a client device.

### BRIEF DESCRIPTION OF THE DRAWINGS

Embodiments of the invention are illustrated by way of example and not limitation in the accompanying figures in which like reference numerals indicate similar elements and in which:

FIG. 1 is a block diagram of an exemplary computing environment suitable for use in implementing embodiments of the invention;

FIG. 2 is a network diagram of an exemplary computing system in which embodiments of the invention may be employed;

FIG. 3 is a block diagram of a spiking query detector in accordance with embodiments of the invention;

FIG. 4 is a block diagram of an intent shift detector in accordance with embodiments of the invention;

FIG. 5 is a graph illustrating changes in query issuance as a function of time in accordance with embodiments of the invention;

FIG. 6 is a graph illustrating a spiked query in accordance with embodiments of the invention;

FIG. 7 is a logic diagram illustrating a method to detect shifts in intent in accordance with embodiments of the invention;

FIG. 8 is a screen shot illustrating a graphical user interface having a response to search terms received at a search engine in accordance with embodiments of the invention;

FIG. 9 is a screen shot illustrating a graphical user interface having a response to a detected intent shift in accordance with embodiments of the invention;

FIG. 10 is a screen shot illustrating a graphical user interface having autosuggests for a partial search term in accordance with embodiments of the invention;

FIG. 11 is a screen shot illustrating a graphical user interface having an alternative autosuggest in accordance with embodiments of the invention;

FIG. 12 is a screen shot illustrating a graphical user interface having an autosuggest with details for one entity in accordance with embodiments of the invention;

FIG. 13 is a screen shot illustrating a graphical user interface having an autosuggest with details for several entities in accordance with embodiments of the invention;

FIG. 14 is a screen shot illustrating a graphical user interface having an autosuggest with an alternative layout for details of several entities in accordance with embodiments of the invention; and

FIG. 15 is a flow diagram illustrating the potential changes in a screen's display of items representing entities in accordance with embodiments of the invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” “component,” etc., might be used herein to connote different components of methods or systems employed, the terms should not be interpreted as implying any particular order among or between various steps herein disclosed unless and except when the order of individual steps is explicitly described.

As utilized herein “autosuggestions” refers to entities, documents, multimedia, persons, companies, etc., provided in a search box to respond to a partial search received at a search engine.

As utilized herein, “query intent” is a user's intent when looking for some particular information through a search engine.

As utilized herein, “query entity intent” is a user's intent when looking for information about an entity.

As utilized herein, “fresh query intent” is a change or update in the query intent. The change in the query intent may occur from time to time based on recent events (e.g., breaking news, etc.). For example, XBOX™ had query intent as XBOX™ 365 while XBOX™ 365 was the most recent formfactor, and recently the query intent for XBOX™ has changed to XBOX™ One.

As utilized herein, “ambiguous query entity intent” is when there might be multiple entities associated with the user's intent. For instance, a query for MS has several entity intents that include a disease, company, gang, or title.

As utilized herein, “temporal context aware query entity intent” is similar to query entity intent that changes from time to time based on the trending events, hot topics, breaking news, or recurring events.

Various embodiments of the technology described herein are generally directed to systems, methods, and computer-readable storage media for, among other things, detecting shifts in query intent. The shifts are detected by a server executing a search engine based on, among other things, temporal signals. In a first embodiment, a query that was not previously issued to the search engine and that suddenly becomes a high frequency query in search engine logs due to new findings, discovery, product release, etc., may have a null intent. This null intent may be shifted by the server to a new intent that is extracted from the click-through results for the high frequency query. For instance, SURFACE™ previously did not have a specific entity intent before its introduction as a product. After its release in news media, SURFACE™ is now associated with an entity intent to the product of Microsoft.

In other embodiments, a recurring query for a specific event may have its intent changed by the server based on the time of year. The query SPECIAL INTEREST GROUP ON INFORMATION RETRIEVAL (SIGIR) refers to a well-known international information retrieval conference. Its entity intent is changed based on the event recurrence cycle. Now, after the search engine receives SIGIR, it will apply an intent of SIGIR 2014 rather than SIGIR 2013, unless the searcher specifies the year.

In other embodiments, a query for a specific entity may have its intent changed by the server based on news events. The query SANDY previously had a number of different minor entity intents to some web sites. After a recent hurricane, the intent for this entity has changed to SANDY hurricane from SANDY person.

In still further embodiments, a query for a specific entity may have its intent changed by the server based on seasonal changes. The query US OPEN has entity intent to [US Tennis Open] during tennis season and has [US Golf Open] as its entity intent during golf season. The server may change the intent during the appropriate season. A query for US OPEN received during the spring may have the intent identified as golf. A query for US OPEN received during the summer may have the intent identified as tennis

To achieve the above functionality of discovering temporal context aware query entity intent, a server is configured to identify trending queries, spiking queries, and fresh entities.

Having briefly described an overview of embodiments of the invention, an exemplary operating environment in which embodiments of the invention may be implemented is described below in order to provide a general context for various aspects of the embodiment of the invention.

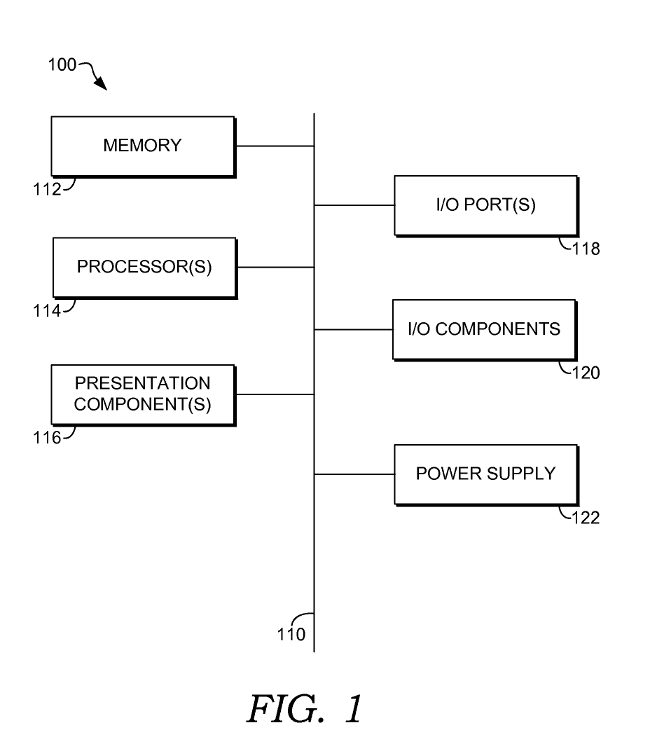

FIG. 1 is a block diagram of an exemplary computing environment suitable for use in implementing embodiments of the invention. Referring to the figures in general and initially to FIG. 1 in particular, computing device 100 is illustrated. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

The embodiments of the invention may be described in the general context of computer code or machine-useable instructions, including computer-executable instructions, such as program components, being executed by a computer or other machine, such as a personal data assistant or other hand-held device. Generally, program components, including routines, programs, applications, objects, components, data structures, and the like, refer to code that performs particular tasks or implements particular abstract data types. Embodiments of the invention may be practiced in a variety of system configurations, including hand-held devices, tablet computers, consumer electronics, general-purpose computers, specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes memories and processors configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows a device to observe shifts in query intents or query entity intent and to provide autosuggests in a search box that receives user query search terms. The autosuggests may include entities or media that is spiking. In addition, the shifts in query intent and query entity intent may be identified as trending, at which point the device may update mappings between the query and the URIs that returned results for the trending query. The device is configured to update search boxes in response to detected spikes. The device may also identify new queries that are received at the search engine in an autosuggest area of the search box.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and metaphorically the lines would more accurately be grey and fuzzy. For example, one may consider a presentation component, such as a display device, to be an I/O component. Also, processors have memory. The inventors hereof recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and refer to “computer” or “computing device.”

Computing device 100 typically includes a variety of computer-readable media. Computer-readable media can be any available media that is accessible by computing device 100 and includes both volatile and non-volatile media and removable and non-removable media. Computer-readable media may comprise computer storage media and communication media.

Computer storage media includes volatile and non-volatile and removable and non-removable media implemented in any method or technology for storage of information, such as computer-readable instructions, data structures, program modules, or other data. Computer storage media includes, but is not limited to, random access memory (RAM), read-only memory (ROM), electronically erasable programmable read-only memory (EEPROM), flash memory or other memory technology, CD-ROM, digital versatile disks (DVDs) or other holographic memory, magnetic cassettes, magnetic tape, magnetic disk storage or other magnetic storage devices, or any other medium that can be used to encode desired data and that can be accessed by the computing device 100. In an embodiment, the computer storage media can be selected from tangible computer storage media like flash memory. These memory technologies can store data momentarily, temporarily, or permanently. Computer storage media does not include and excludes communication media.

On the other hand, communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media.

Memory 112 includes computer storage media in the form of volatile and/or non-volatile memory. The memory may be removable, non-removable, or a combination thereof. Exemplary hardware devices include solid-state memory, hard drives, optical-disk drives, etc. Computing device 100 includes one or more processors 114 that read data from various entities, such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices, including I/O components 120, some of which may be built in. Illustrative I/O components include a microphone, joystick, game pad, satellite dish, scanner, printer, wireless device, controller (such as a stylus, keyboard, and mouse), or natural user interface (NUI), etc.

The NUI processes gestures (e.g., hand, face, body, etc.), voice, or other physiological inputs generated by a searcher. These inputs may be interpreted as queries, requests for information or entities, or requests for interacting with multimedia content (e.g., audio video, webpage, blog, etc.). In one embodiment, spiking entities are detected for inclusion in an autosuggest area provided by a search engine. The autosuggests may be interacted with to view additional entities or information in a vertical manner or in a horizontal manner in certain embodiments. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and gaze recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

As previously mentioned, embodiments of the invention are generally directed to systems, methods, and computer-readable storage media for, among other things, detecting shifts in query intent or query entity intent. In some embodiments, the interaction with search results may be analyzed to observe the intent shifts. The search logs and news sources may also be mined to detect spiking queries and trending queries. The intent shifts may be identified from the spiking queries or trending queries.

Various aspects of the technology described herein are generally employed in computer systems, computer-implemented methods, and computer-readable storage media for, among other things, providing entity information in a search box. The computer system, in some embodiments, may include a search engine, one or more entity databases, one or more search logs, and several servers. The one or more entity databases may store entity and uniform resource identifier (URI) mappings. The search logs may store queries executed by the search engine. The servers are configured to execute the following a fresh intent detector, a filter component, and a rendering component to provide one or more autosuggest for an autosuggest area of a search box provided by the search engine.

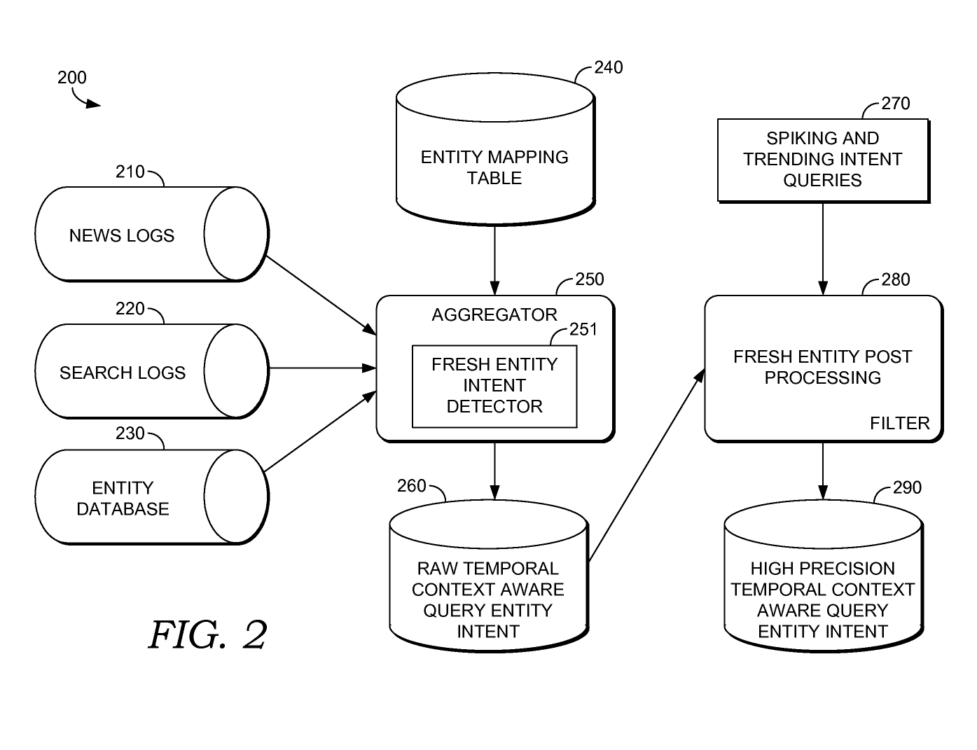

FIG. 2 is a network diagram of an exemplary computing system in which embodiments of the invention may be employed. The computing system 200 may include a news logs 210, search logs 220, entity database 230, and entity mapping database 240. The computing system 200, also, includes one or more servers executing, among other things, aggregator 250 and filer 280. The server may produce both a raw temporal context aware query intent database 260 and a high precision temporal context aware query intent database 290. The high precision temporal context aware query intent database 290 is generated upon applying trending and spiking signals to the raw temporal context aware intent database 260. In at least one embodiment, the high precision temporal context aware query intent database 290 is accessed by the computing system 200 to provide one or more potential autosuggests that may be displayed to a user entering terms into a search box at a search engine.

The news logs 210 store multimedia content describing recent events. The multimedia content includes video, documents, and audio. The news logs 210 are updated frequently. For instance, the news logs 210 may be updated every 5 minutes. The news logs 210 may include current information about events, people, places, or things. In at least one embodiment, the new logs 210 may identify one or more queries which trigger search results that contain news content or URIs for news stations.

The search logs 220 store the queries entered by the user, results returned, and click-through for the URIs included in the results. The queries stored in the search logs 220 may include entity queries. In some embodiments, the search logs 220 stores a timestamp for each query. The timestamp represents the day, hour, minute, second, etc. that the query is received. The search logs 220 store the number of queries received by the search engine; number of clicks, hovers, etc., received from a client device for each URI returned in response to the query; and at least one identifier for each of the URIs interacted with by the user of a client device.

The entity database 230 stores information on entities. The database may store attributes about the entity. The attribute may indicate whether the entity is person, place, document, movie, song, etc. Additional attributes may include a brief description of the entity. The entity database 230 may be provided by a third party. Entities may be identified from news stories or social media blogs. In one embodiment, the entity database 230 may be provided by a social media provider or a contact aggregator. In other embodiments, the entity database 230 also stores the entities and the URIs that are mapped to the entities. The URIs in the entity database 230 are extracted from search results that are interacted with in response to a query specifying a corresponding entity. The interactions may include clicks, hovers, gestures, voice commands, etc., received from a client device employed by a user. The query is processed by the search engine to return the search results. The entity database 230 may be updated to reflect a new mapping when the URIs interacted with for an existing entity change to a different set of URIs.

The entity mapping database 240 stores the entities and the queries that are mapped to the entities. The entities identified in the entity database 230 may also be included in the entity mapping database 240. The queries in the entity mapping database 240 are extracted from search logs having queries where the user interacted with one or more URIs specifying a corresponding entity. The interactions may include clicks, hovers, gestures, voice commands, etc., received from a client device employed by a user. The query and entity are stored in the entity mapping database 240, which may be updated to reflect a new mapping when the URIs interacted with for an existing query change to a different set of URIs.

The aggregator 250 merges the information from several sources. Here, the aggregator 250 merges the news logs 210, search logs 220, entity database 230, and entity mapping database 240. The aggregator 250 processes the merged data to determine whether fresh query intents or fresh query entity intents exist in the merged data. In some embodiments, the aggregator 250 is configured to execute a fresh intent detector 251. The fresh intent detector 251 is configured to identify shifts in intent for recurring queries in the news logs 210, search logs 220, entity database 230, and entity mapping database 240. In turn, the fresh intent detector 251 identifies intents for new queries in the search logs and updates mappings between an entity and a query based on the identified shifts in intent or the identified new intents. The updated mappings between an entity and query are included in the raw temporal context aware query intent database 260. The shifts in intent are detected based on an analysis of changes in URI interaction data that converge on a different URI associated with a different or new entity.

The raw temporal context aware query intent database 260 is configured to provide updated mappings for, among other things, queries that are new, recurring, or that have changed. For instance, Harry Shum is the name for an actor on Glee and an executive vice president of Microsoft. Before Glee became a popular query term, a search for Harry Shum would consistently list the executive vice president of Microsoft. Now, because Glee was very popular and trending, the query with the name Harry Shum returns a cast of Glee actors or the biographic summary for the actor Harry Shum. The Glee event changed query intent because Glee actor is more dominant in sources and in the user click-through. The executive vice president has taken a secondary place to the actor.

In addition to updated mappings for existing queries, the raw temporal context aware query intent database 260 stores new queries that are mapped to URIs and entities of the entity database 230 or mapping database 240. For instance, a song release (e.g., You Only Live Once (YOLO) may cause users to issue queries for the term YOLO. This term may not be included in the entity database 230 or the entity mapping database 240. The search logs 220 and news logs 210 may contain some information about the song. Thus, based on the user interaction with URIs or news data corresponding to the query for the term YOLO, the computing system 200 may learn a new entity, YOLO music media, and may include a new mapping between the query YOLO and YOLO music media as opposed to treating this term as an error and correcting it to POLO. Thus, the computing system 200 stores the new query and new mapping in the raw temporal context aware query intent database 260

Recurring queries and updated mappings are also made available in the raw temporal context aware query intent database 260. For instance, some queries are seasonal because they are only issued in large volume during a specific time frame (e.g., pumpkin soup, pumpkin pie recipe, turkey, Thanksgiving). Similarly, certain query intents and query entity intents are seasonal. That is, the user intent changes based on the time of year. For instance the query US OPEN may have different intents based on the time of the year. During the spring season, the query intent may refer to golf. During the summer season, the query intent may refer to tennis The raw temporal context aware query intent database 260 updates the query mapping to match the query intent based on the time of year and user interaction information included in the search logs. During summer time, an analysis of the search logs by the computing system 200 may reveal that users are no longer interacting with golf results but are interacting with tennis results. Accordingly, the summer months' version of the raw temporal context aware query intent database 260 will have a different mapping for US OPEN than the spring months' version of the raw temporal context aware query intent database 260. The fresh intent detector 251 may identify one or more entities for the queries based on the date such that seasonal queries map to different entities based on the time of year.

A spiking and trending component 270 identifies queries that are currently spiking or trending. The queries are identified by observing query frequency over a specified time period. In some embodiment, query count if graphed over the specified time period and the computing system 200 measures a rate of change for the count and the volume of the query. In turn, based on these measurements, the computing system 200 informs the spiking and trending component 270 that a query is spiking or is trending.

The filter 280 processes the raw temporal context aware query intent database 260 to provide a refined output that retains query mappings for queries that are identified as trending or spiking by the spiking and trending component 270. In one embodiment, the queries are identified as spiking based on a volume increase within a short period of time. In other embodiments, the queries are identified as trending based on a sustained volume increase over a long period of time.

The filter 280 receives the updated mappings between queries and entities stored in the raw temporal context aware query intent database 260. The filter 280, in certain embodiments, keeps queries corresponding to spiking and trending entities and removes the remaining queries. The filter 280 may reduce the mappings in the raw temporal context aware query intent database 260 and produce the high precision temporal context aware query intent database 290.

The high precision temporal context aware query intent database 290 stores the mappings for the spiking and trending queries filtered from the raw temporal context aware query intent database 260. In turn, these mappings may be processed by the computing system 200 to provide autosuggests for users that are entering search terms in a search engine. Alternatively, the computing system 200 may update the entity mapping database 240. In certain embodiments, the query and URI mappings that are provided as autosuggests are selected from the set of spiking queries. In other embodiments, the updates to the URI and entity mappings or query and entity mappings are stored in the entity database 230 or the entity mapping database 240, respectively.

In an embodiment, a rendering component (not shown) may include the filtered mappings for the entities and queries in the autosuggest area of a search box provided by the search engine accessed by the user. The search box may be updated with the autosuggests as the user enters characters in the search box. The search box may be updated with additional autosuggests for other entities based on the user interaction with the items in the autosuggest area of the search box. In one embodiment, the search box includes an autosuggest area that is updated with a list of previewable entity suggestions that may be scrolled through vertically or horizontally within the autosuggest area. The list of previewable entity suggestions may include multimedia content and visual representations for the entities associated with the queries. The suggestions may be scrolled through in response to a gesture. Also, the suggestions may be scrolled through in response to touch.

The computing system 200 may include a network that communicatively connects the client computing devices, servers, and databases to each other. The network may include, without limitation, one or more local area networks (LANs) and/or wide area networks (WANs). Such networking environments are commonplace in offices, enterprise-wide computer networks, intranets, and the Internet. Accordingly, the network is not further described herein.

It should be understood that any number of client computing devices and servers may be employed in the computing system 200 within the scope of embodiments of the present invention. Each may comprise a single device/interface or multiple devices/interfaces cooperating in a distributed environment. For instance, the server may comprise multiple devices and/or modules arranged in a distributed environment that collectively provide the functionality of the server described herein. Additionally, other components/modules not shown also may be included within the computing system 200.

Embodiments of the invention detect both spiking and trending queries. The search logs or news logs are processed by the computing system to generate histograms for the query terms. The histograms provide insight into the distribution of each query over a specific period of time. In one embodiment a log of 19 months of query data is analyzed to determine which queries spike and the corresponding time frame. In turn, the spiking queries may be returned as autosuggests during a relevant time period associated with the spiking query.

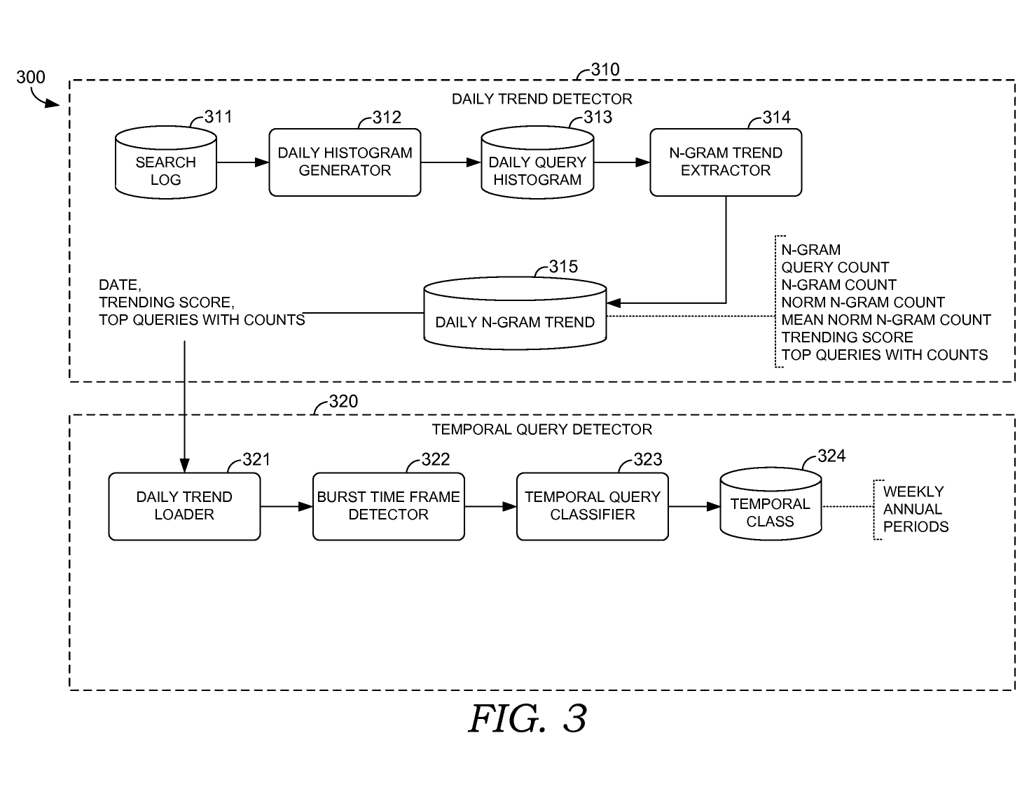

FIG. 3 is a block diagram of a spiking query detector 300 in accordance with embodiments of the invention. The spiking query detector 300 may be executed by a server that is configured to identify a query as spiking. The spiking query detector 300 may provide additional insights into whether a query is spiking infrequently, yearly, quarterly, monthly, daily, or hourly.

The spiking query detector 300 may include a daily trend detector 310 and a temporal query detector 320. The daily trend detector 310 includes search log 311, histogram generator 312, histogram storage 313, N-gram trend extractor 314, and N-gram trend storage 315.

The search log 311 stores records having queries received at the search engine, the queries executed by the search engine, and the results returned in response to the queries. The search log may include a timestamp for each query received by the search engine.

The histogram generator 312 generates one or more histograms over a specific time period. The time period may vary from less than three hours, more than three hours, or years. The histogram shows the distribution of each query over the specified time periods. The histograms generated by the histogram generator are stored by the spiking query detector 300. In certain embodiments, the histograms may also include entity information extracted from the search results included in the search log. Like a query histogram, the entity histogram shows a distribution of user interaction with the entity of a specific time period.

The spiking query detector 300 may store the histograms in the histogram storage 313. The histogram storage 313 stores the histograms for further processing. The histograms may be used to identify the spiking queries/entities, to detect the time periods for the spiking queries/entities, and to determine whether a spiking query/entity becomes a trending query/entity. The stored histograms are processed by the N-gram trend extractor 314.

The N-gram trend extractor 314 identifies potential N-grams from the search terms included in each query/entity of the histogram. The N-gram trend extractor 314 compares the volume of the identified n-grams over each time period to determine whether the query is spiking or trending. The N-gram trend extractor 314 may identify each query and the count (appearance) for the query. Each query may have one or more potential n-grams identified. In turn, the N-gram trend extractor 314 counts the identified n-grams, the mean of n-gram counts for each query, and the normal for N-gram count. The queries with the highest appearance counts may be selected as candidates for identification as spiking or trending. In one embodiment, when the count for a query or N-gram is above a specific threshold for a period of time (e.g., 6 hours), the query is identified as trending. On the other hand, when the count is above a specific threshold for a period of time (e.g., between 2-6 hours), the query is identified as spiking.

The N-gram trend storage 315 stores the measure calculated by the N-gram trend extractor 314. For each N-gram, the N-gram trend storage 315 records n-gram count, normal for the N-gram count, and mean for the N-gram count. Additionally the records provide time periods corresponding to the N-gram, N-gram count, normal for the N-gram count, and mean for the n-gram count. For each query, the N-gram trend storage 315 records query count, normal for the query count, and mean for the query count. The N-gram trend storage 315 may store an indication of whether the query is trending or spiking.

The daily trend detector 310 communicates with the temporal query detector 320 to determine which queries are seasonal, spiking, trending etc. The temporal query detector 320 executes the following items daily trend loader 321, burst time frame detector 322, and temporal query classifier 323. The temporality of the query is stored in temporal class storage 324.

In turn, the daily trend loader 321 obtains the daily records from the N-gram trend storage 315. The daily trend loader 321 may calculate additional statistics for the queries or N-grams on each day of a specific time period (monthly, weekly, quarterly). For instance, the daily trend loader 321 may calculate the standard deviation, and mean of any outliers for each query. An outlier, in one embodiment, occurs when query volume of a particular day is larger than 2 times of the mean or mean plus 2 times of the standard deviation.

The burst time frame detector 322 identifies one or more queries that satisfy criteria set by the spiking query detector 300. The criteria, in one embodiment, are received from the temporal query classifier 323. For example, the spiking detector may specify that a query is spiking when the volume is over two million appearances within one hour on a single day. The burst time frame detector 322 processes the records of the N-gram trend storage 315 to determine the set of queries that satisfy the specified condition.

The temporal query classifier 323 may specify the conditions that distinguish between a seasonal query, a trending query, a spiking query, and a recurring query. For instance a seasonal query occurs with a predictable volume during a specific time period. For instance, a query may be seasonal when the volume is over 2.5 M per day during the August, September, and October months each year. A trending query is a query that is consistently over 10 M per day for three consecutive days, in some embodiments. A spiking query, in one embodiment, is a query with over two million appearances within one hour one a single day. A recurring query is a query that has over five million appearances every day of a week in certain embodiments.

The temporal class storage 324 clusters the queries classified by the burst time frame detector 322. Each query classified as seasonal is stored in a seasonal partition of the temporal class storage 324. Each query classified as spiking is stored in a spiking partition of the temporal class storage 324. Each query classified as recurring is stored in a recurring partition of the temporal class storage 324. Each query classified as trending is stored in a trending partition of the temporal class storage 324.

The spiking query detector 300 may identify each query and the temporal class for the query along with the relevant time periods for the query. The output of the spiking query detector 300 may be provided to the entity mapping or entity tables for updating if necessary. The spiking detector may transmit the query, temporal class, times, repeating pattern if any, and trending score.

In other embodiments of the invention, the computer system is also configured to detect shifted intents for the queries (a seasonal query, a trending query, a spiking query, and a recurring query). The shifted intent may be observed based on changes in user interaction with URIs returned in response to the queries. For example, the meaning of the query US OPEN shifts based on time of year.

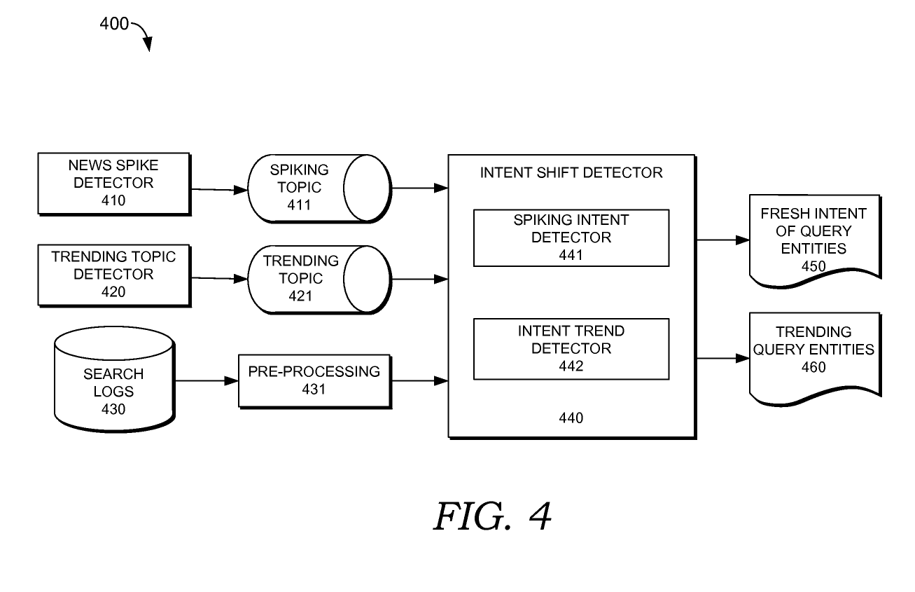

FIG. 4 is a block diagram of the intent shift detector 440 in computer system 400 in accordance with embodiments of the invention. The computer system 400 may include news spike detector 410, trending topic detector 420, search logs 430, and intent shift detector 440.

The news spike detector 410 identifies spikes in news, journal, social media information, or queries requested by searchers. The news spike detector 410 may specify a time window and volume expected before a spike is identified in at least one embodiment. The news spike detector 410 may observe increases in volume for the news information within a configurable window (e.g., 6 hours and under). The news information that meets the spiking criteria is processed to extract topics included in news information. The topics may be extracted from the new sections, titles, subheadings, etc. The spiking topics may be stored in spiking topic storage 411.

In some embodiments, the spiking topic storage 411 records the extracted topics and the time corresponding to the news information having the extracted topics. The time may include day, hour, minute, year, etc. The spiking topic storage is updated frequently. For instance, the spiking topic storage may be update hourly, every 6 hours, or any other reasonable time frame.

The trending topic detector 420 of the computer system 400 may identify the trending topics in several sources including news/journals and queries issued by searchers. The trending topic detector 420 may specify a time window and volume expected before a trend is identified in at least one embodiment. The time window specified for the trending topic, in most embodiments, is selected to be larger than the window of the spiking topic. The trending topic detector 420 may observe increases in volume for the news information or search requests within a configurable window (e.g., 7 hours and over). The news information or search requests that meet the trending criteria are processed to extract topics included in news information and search requests. The topics may be extracted from the new sections, titles, subheadings, etc. The trending topics may be stored in trending topic storage 421.

In some embodiments, the trending topic storage 421 records the extracted topics and the time of the news information or search request having the extracted topics. The time may include day, hour, minute, year, etc. The trending topic storage 421 is updated frequently. For instance, the trending topic storage may be updated every 7 hours, 14 hours, or any other reasonable time frame.

The search logs 430, as explained above, store the queries issued by the searchers at a search engine. The count for each query may be stored in the search logs, in at least on embodiment. The search logs 430 may also store the user interaction information like the number of results returned for each query, the URIs for the results interacted with by the user, and the length of time the user dwelled on the URI. Accordingly, the search logs may provide a query to URI mapping.

The search logs 430 are sent to pre-processing 431 which removes redundant information. The pre-processing 431 may combine queries that are substantially similar but keep the timestamp information to aid in determining the distribution for the query. The pre-processing 431 may also calculate statistics from the information included in the search logs to identify the freshness of queries entered by the user. In some embodiments, the pre-processing 431 may identify entities that correspond to the URIs interacted with by the user. In turn, mappings between the queries and identified entities are generated by the computer system 400.

The intent shift detector 440 records whether a shift in intent is occurring based on, among other things, user interaction with news information and URI results. The intent shift detector 440 may execute a spiking intent detector 441 and an intent trend detector 442. The intent shift detector 440 is configured to determine when a shift occurs in the new information, search logs, etc. For example, during hurricane season, Isaac and Sandy, which are normally names for people, may be shifted to names for hurricanes.

The spiking intent detector 441 processes the information provided by the spiking topic storage 411, trending topic storage 421, and pre-processing 431. The spiking intent detector 441 determines whether a new or recurring query has a fresh intent at a given time frame. In some embodiments, the query is an entity query.

The spiking intent detector 441 may provide the following based on the analysis of the information provided by spiking topic storage 411, trending topic storage 421, and pre-processing 431. The output of processing may include an identification of a query, raw intent, and spiking time. The following table shows an illustration of the query, raw intent, and spiking time provided.

| Query | Raw Intent | Spiking Time |
|---|---|---|
| Abbot | Tony Abbott plane lost | Time (General time format) |
| Abbott | Tony Abbott plane accident | Time (General time format) |

The query or topic is identified by the computer system 400. In turn, the intent is detected by the intent shift detector 440. The fresh intent is selected from the analysis of the spiking topic storage 411, trending topic storage 421, and pre-processing 431. For Abbott, the Malaysian plane mystery discussed by Tony Abbott may be the raw intent as opposed to the corporation. The date for when this intent is spiking is extracted from the spiking topic storage 411.

In one embodiment, the information from the spiking topic storage 411, trending topic storage 421, and pre-processing 431 may be processed by the computer system to generate entity groups. An entity may be extracted from each topic in the spiking topic storage 411, trending topic storage 421, and pre-processing 431. The computer system may cluster the groups that are partitioned based on the timestamp. For instance, query ABBOTT PLANE LOST with 2014-3-19-09 PM starting timestamp is associated with an entity TONY ABBOTT with 2014-3-19-09 PM starting timestamp. Additional queries are grouped in the cluster of the entity group named as TONY ABBOTT.

In some embodiments, the appearance frequency for each topic may be normalized by the spiking intent detector 441 to allow comparison across time periods. In turn, the spiking intent detector 441 may generate a spiking score with the number of spikes for the query/entity, the periodicity of the query/entity, and the overall trend in popularity for the query/entity. In at least one embodiment, if the score is above a specific threshold, the query/entity may have a fresh intent that has shifted.

In one embodiment, click-through user interaction data in search logs is checked to confirm shifts in intent. The computer system 400 may access the search result click-through for the query/entity. The computer system may check to determine whether the URIs are related to news sources or existing web content. During a spiking period, the computer system 400 may observe an increase in user interaction with content from news sources. For each query/entity, the computer system may compare the click-through rate for the news articles included in the search results and the click-through rate of existing web content included in the search results. The results of the comparison provide an indication that intent shifts are likely. Accordingly, the computer system 400, in certain embodiments, confirms that the shift in intent from existing web content to new sources has occurred for each spiking query/entity.

In at least one embodiment, the probability of the intent shift for query/entity is estimated from click entropy. Click entropy provides the computer system 400 with a direct indication of query click variation. Smaller click entropy indicates general user agreement with each other on a small number of web pages. For example, if all users click only one page for a query, the entropy is 0.

The click entropy of a query (q) may be calculate as follows:

$$ClickEntropy ( q ) = {\sum }_{p ∈ P ( p )} - P ( p \vert q ) {log}_{2} P ( p \vert q ) ,$$

P(q) is the collection of web pages clicked on query q. P(plq) is the percentage of the clicks on URI p among all the clicks on q. The computer system 400 may exclude queries having <N users (e.g., N>2). The changes in click entropy may reveal that the users have shifted intent for the query. For instance, clicks on news articles could support the computer systems likely shifting intent evaluation when the previous click-through behavior of the query had different content interaction distribution.

The intent trend detector 442 provides insights into the intent for trending queries. The trending queries are the queries with a sustained volume for a period of time (e.g., 7 hours or more). The computer system 400, in an embodiment, may identify trending query entities 460 based on analysis of the trending queries.

The intent trend detector 442 may obtain information from the trending topic storage 421 and the search logs 430. Each topic include in the trending topic storage 421 is normalized by removing extraneous characters—such as punctuation marks, stop words, etc. In one embodiment, the normalization removes synonymous topics included in the trendin topic storage 421. In other embodiments, the normalization keeps synonymous topics.

The intent trend detector 442 may generate histograms of the trending topics and compute trend slope of normalized topics based on a historical histogram. Historical histogram data contains previous topic frequency information. In one embodiment, the intent trend detector 442 computes the trend slope between the time of trend start and time of relatively stable volumes for the topics of interest. The trend slope is processed by the intent trend detector 442 to generate a trend score

The trend score of the trending topic is calculated by the intent trend detector 442 as a product of the trend slope, current frequency of the topic in the search results, and current click entropy for the topic. In some embodiments, the trend slope, frequency, and entropy are weighted. The weights applied to the trend slope, frequency, and entropy may differ from one another. The weights may be based on business rules for a search engine.

The trending query entities 460 may be based on the trending topics. The intent trend detector 442, in one embodiment, generates an entity of a trending topic by using an entity extractor or simple N-gram matching methods. For example, an entity of the trending topic mini review could be CAR. The computer system 400 may parse queries having the trending topic to identify entities. Optionally, the computer system 400 may parse the search results interacted with in response to the topic to identify entities. The top 5 trending topics with largest trend scores may be selected by the intent trend detector 442 to extract entities for the trending query entities 460.

If a trending topic (e.g., SURFACE) has multiple entities {E1, E2, E3, . . . }, the intent trend detector 442 may calculate several trend scores {Q1, El, T1}, {Q1,E2, T2}, etc.

The following table illustrates the multiple entities for a trending topic:

| Trending Topic | Entity | Trend score |
|---|---|---|
| Surface | Surface RT | 0.90 |
| Surface | Surface PRO | 0.63 |
| Surface | Surface 2 | 0.30 |

Accordingly, the computer system processes spiking topics, trending topics, and query search logs to detect fresh intents, shifts in intent, the trending entities, and the spiking entities. The shifts in intent may be used to provide autosuggest in some embodiments. In other embodiments, the shifts in intent may be recorded to update mappings between entities and queries or queries and URIs.

Embodiments of the invention process histograms to identify spiking and trending topics, queries, or entities. The computer system may generate the histograms from search logs or news information. In some embodiments, the histograms are generated for each entity extracted from a topic or query.

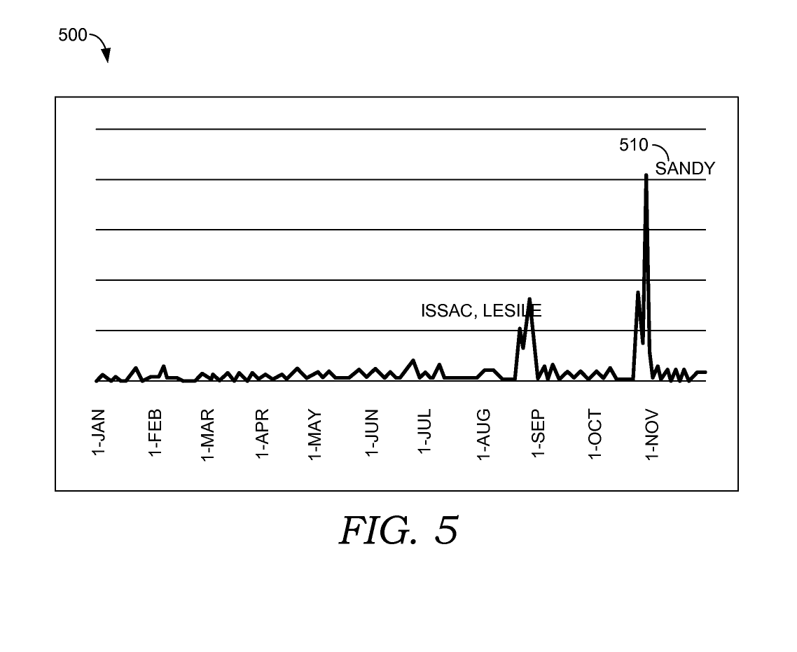

FIG. 5 is a graph illustrating changes in query issuance as a function of time in accordance with embodiments of the invention. The histogram 500 provides the distribution of the hurricane entities: ISSAC, LESLIE, and SANDY, during hurricane season. The histogram 500 provides the computer system with an indication of when the query volume changes and the length of time associated with changed volume. The histogram 500 shows that SANDY 510 had the largest increase in query volume. The computer system may use this information to identify SANDY 510 as a spiking query, topic, or entity, in certain embodiments of the invention.

The computer system identifies the spikes based on an indication of at least two indicators: volume and time. A query, topic, or entity may spike based on user interaction or user's searching for the corresponding information. In other embodiments, the spikes may correspond to new information released to the public.

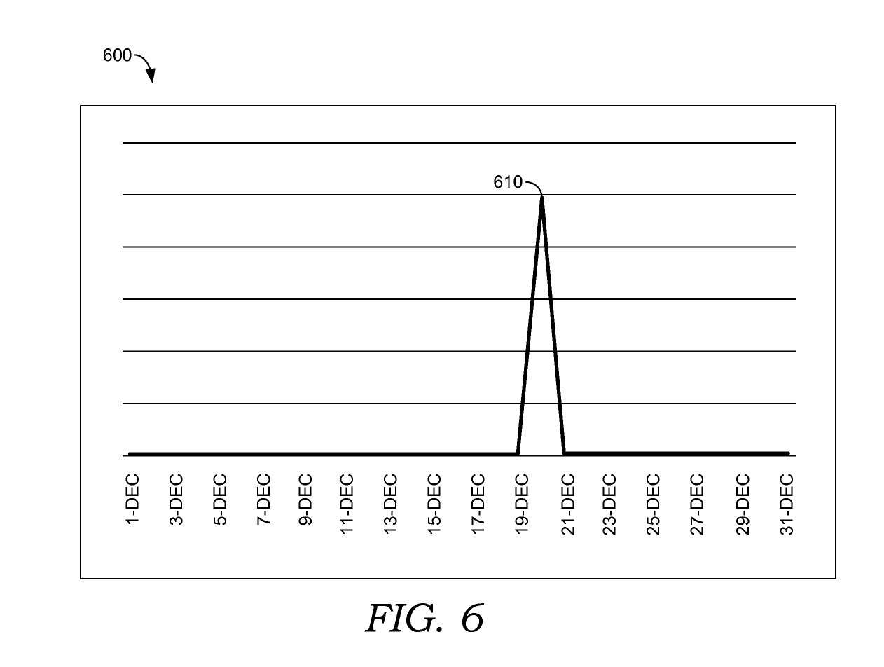

FIG. 6 is a graph illustrating a spiked query in accordance with embodiments of the invention. The histogram 600 generated by the computer system provides a distribution of the queries. The histogram 600 provides an indication of the volume and length of time that is analyzed by the computer system. The histogram 600 shows an increase in volume between 19 December and 21 December. In one embodiment, the query may be related to shipping or flights.

The computer system is configured to detect shifts as explained above. In some embodiments, the computer system determines whether a query is spiking or trending. In turn, the computer system may include the query in an autosuggest area when the query is spiking. Alternatively, mappings between queries and URIs may be updated if the query is trending.

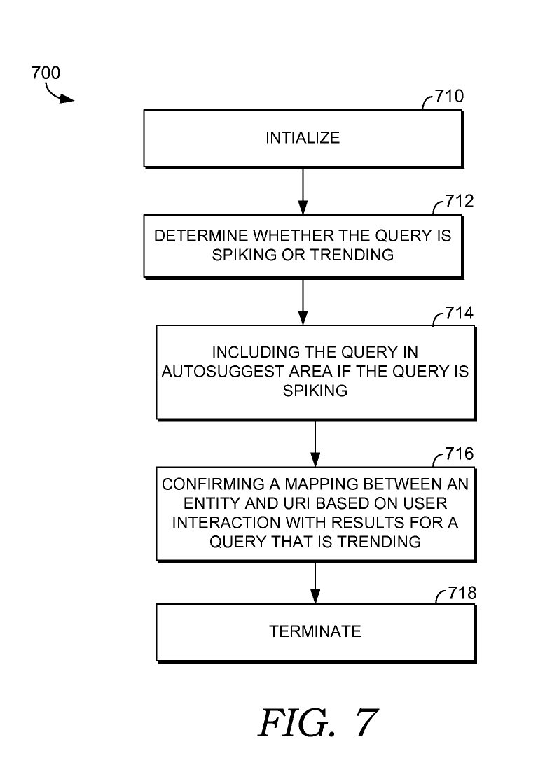

FIG. 7 is a logic diagram illustrating a method 700 to detect shifts in intent in accordance with embodiments of the invention. The method initializes in step 710. The computer system in step 712, determines whether a query is trending or spiking.

When the query is spiking, in step 714, the computer system includes the query in an autosuggest area provided by the search engine. The autosuggest area, in one embodiment is provided in response to search terms entered at a client device. In certain embodiments, the query is identified by the computer system as spiking when the search volume increases significantly (e.g., 1 million or more queries) over a window of between 30 minutes and 3 hours.

In step 716, the computer system, when the query is trending, confirms a mapping between an entity represented by the query and uniform resource identifiers (URIs). The URIs may be selected from query search results accessed by client devices that issued the trending query. The computer system, in some embodiments, identifies the query as trending when a search log maintained by the search engine has an increased volume for the query over a period of at least 4 hours.

In at least one embodiment, the computer system may identify an intent shift for the query. The shift may be detected based on, among other things, changes in URI access or click-through information for the query. The computer system may determine whether the accessed URIs of the results for a spiking query are linked to an entity different from an entity stored in a search log for the search engine. The search log may store previous results for the query before it was spiking. The method terminates in step 718.

Accordingly, the computer system may detect shifted intents for either spiking or trending queries. The computer system may surface spiking queries to the searchers as search terms are entered in a search box on the client devices. Additionally, if available, query URI mappings may be updated to reflect shifts in intent for the trending queries. The computer system provides both temporal and context awareness to searchers that look for recent content.

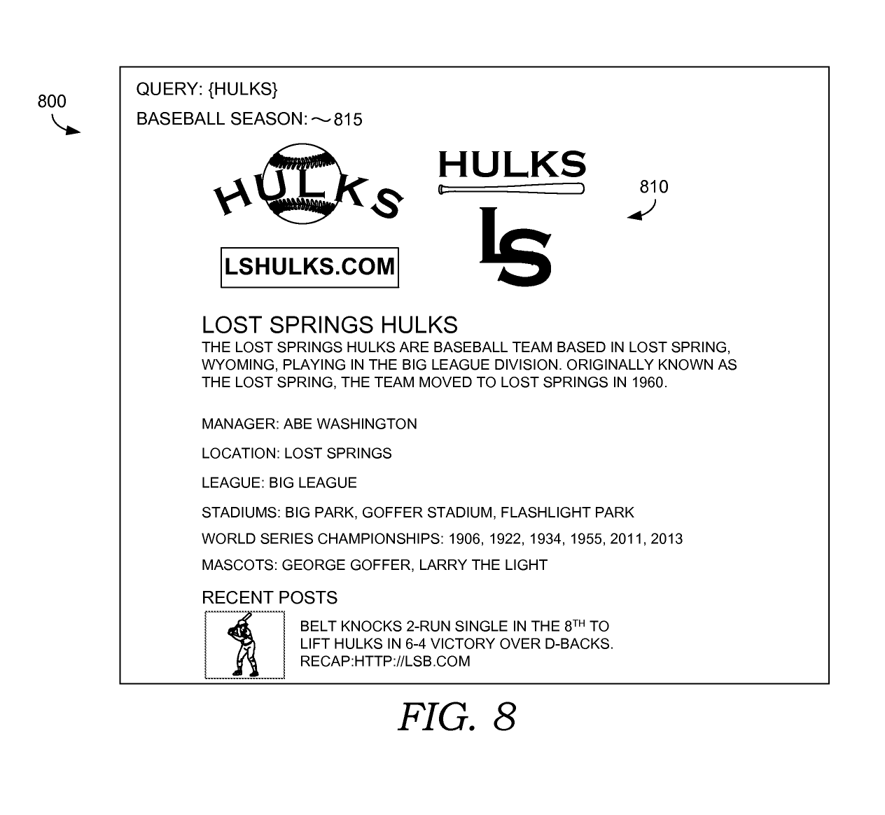

The graphical user interfaces provided to a client device may be configured to identify shifted intents based on time of year and user location. The relevant information for entities is presented in the graphical user interface. FIGS. 8-15 provide screen shots that illustrate the shifting intents for user queries that are provided in a graphical user interface of a client device in accordance with embodiments of the invention.

FIG. 8 is a screen shot illustrating a graphical user interface 800 having a response to search terms received at a search engine in accordance with embodiments of the invention. As a user enters a query for HULKS, the user may receive a summary page 810 for a corresponding team. The summary page 810 may include information about the team, owner, stadium, location, etc. Because HULKS refers to a baseball team and a football team, the computer system may identify the current time of year associated with the query. In turn, the computer system offers the HULKS baseball team as potential completion in the search box if the current time of year is March until August. During football season (e.g., September until February), the computer system may offer the HULKS football team as a potential completion in the search box.

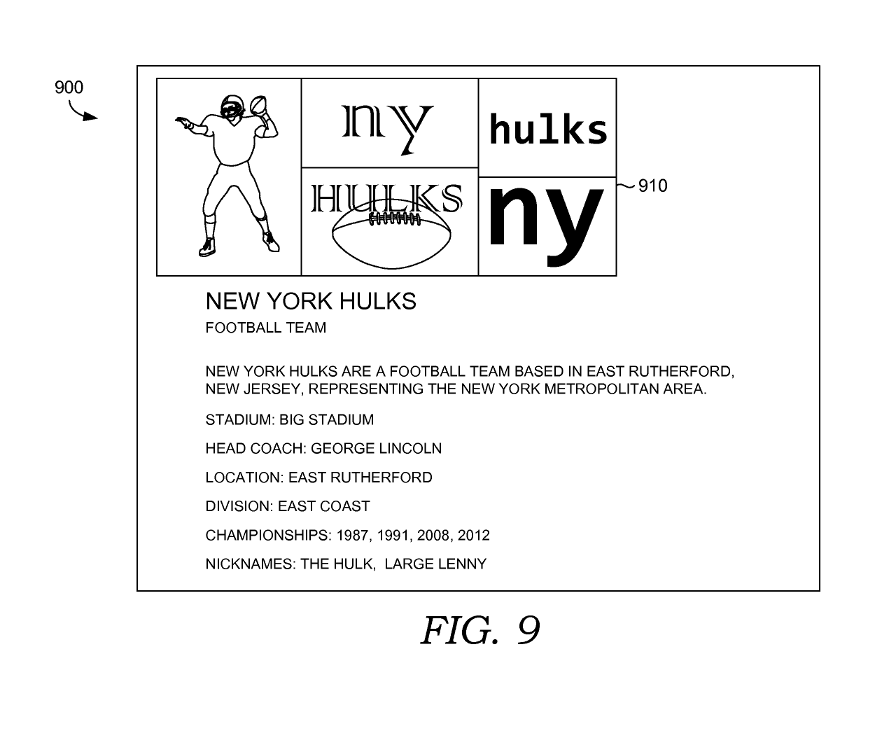

FIG. 9 is a screen shot illustrating a graphical user interface 900 having a response to a detected intent shift in accordance with embodiments of the invention. When the sport seasons transition from baseball to football, the computer system may detect a shift based on user interaction information for the webpages or content corresponding to HULKS baseball and football. As the baseball season closes, the interaction for the content for HULKS football increases.

In turn, the computer system offers the HULKS football team as potential completion in the search box if the current time of year is September until February. The search box may be updated with a biographical summary page 910. The summary page 910 may include information about the team, owner, stadium, division, location, etc. In some embodiments, the entity is selected based on the location of the user. For instance, the location for the user that is receiving the biographical summary must be located within the division identified in the summary page.

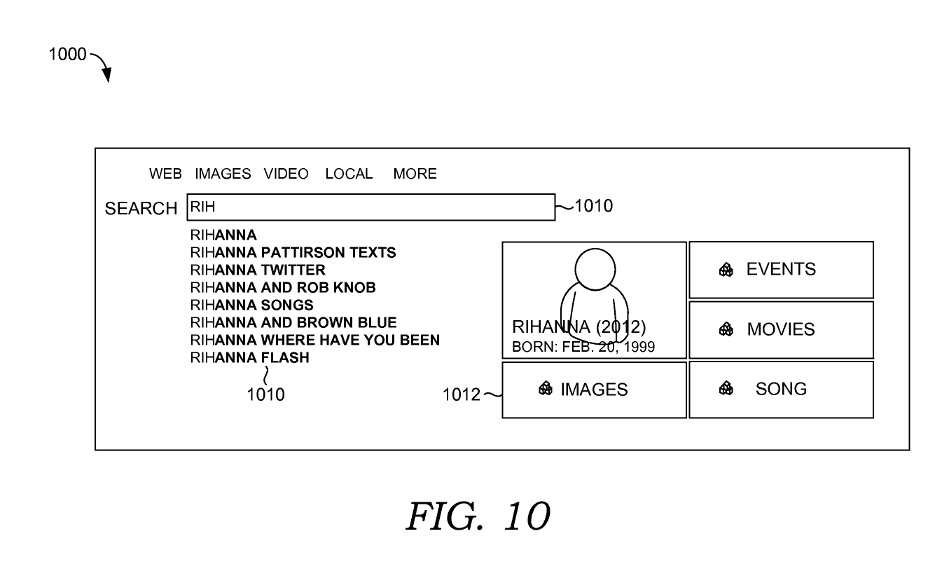

FIG. 10 is a screen shot illustrating a graphical user interface 1000 having autosuggests 1011 for a partial search term in accordance with embodiments of the invention. As a user enters search terms RIH in a search box 1010, the user may receive autosuggests 1011. The autosuggests 1011 may include topics, images, media, etc. The computer system may select autosuggests 1011 from a set of the spiking queries. In some embodiments, the autosuggests 1011 that complete the search term are returned for display in the search box that is receiving the search terms from the user. The autosuggests 1011 selected by the computer system may include images 1011a, movies 1011b, songs 1011c, etc., that correspond to an entity. In at least one embodiment, the entity is a spiking entity.

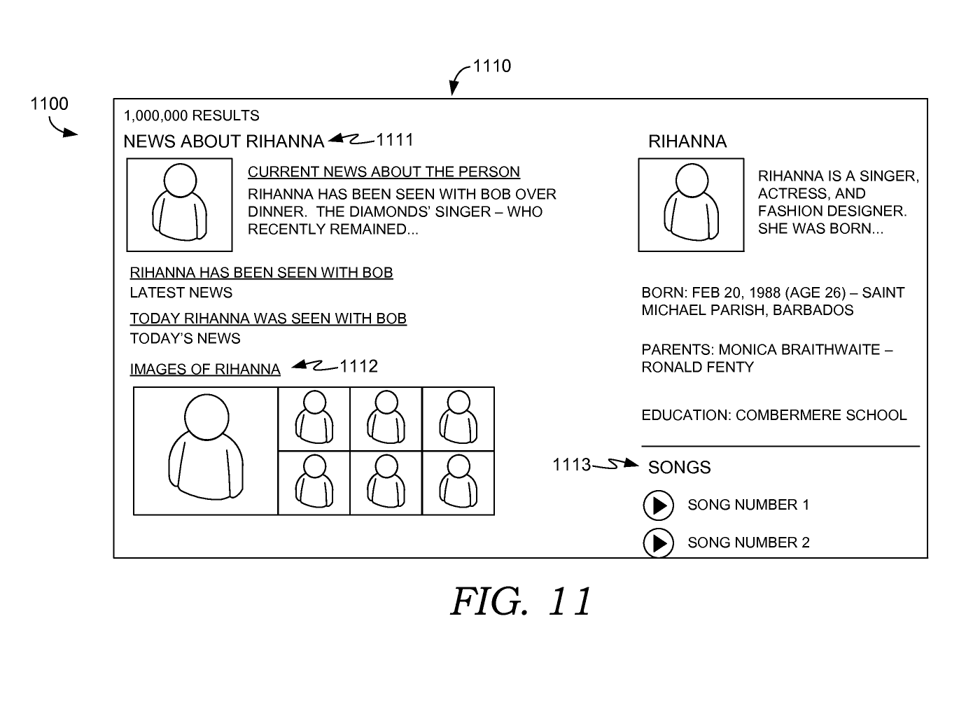

FIG. 11 is a screen shot illustrating a graphical user interface 1100 having an alternative autosuggest 1110 in accordance with embodiments of the invention. As a user enters search terms RIH in a search box, the user may receive autosuggests 1110. The autosuggest 1110 may include news 1111, images 1112, media 1113, etc. The computer system, in one embodiment, may return autosuggest 1110 because it is included in a set of the spiking queries and it is also a potential completion for the received search terms. The autosuggests 1110 may be clustered around a single entity in at least one embodiment of the invention.

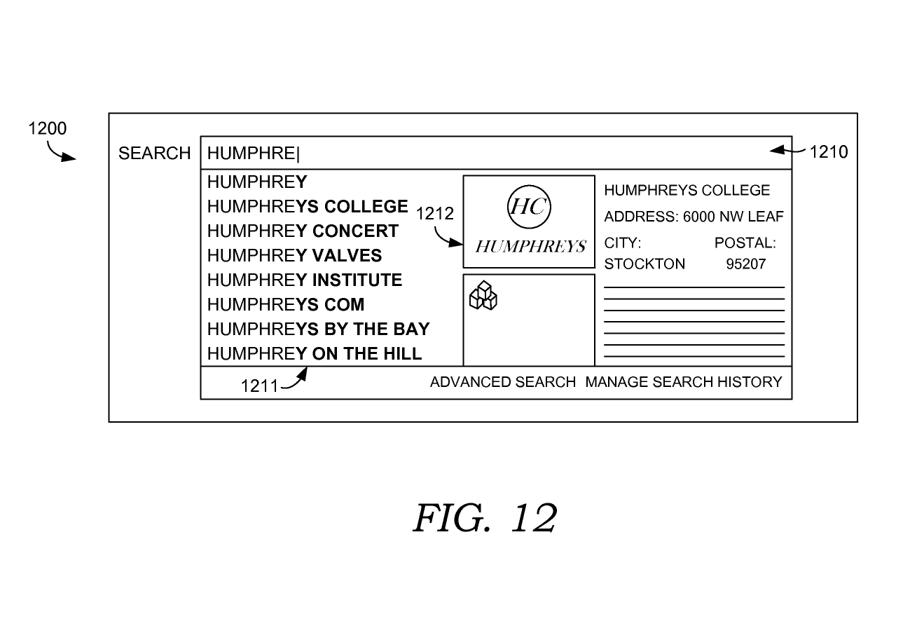

FIG. 12 is a screen shot illustrating a graphical user interface 1200 having an autosuggest 1211 with details 1212 for one entity in accordance with embodiments of the invention. As a user enters search terms HUMP in a search box 1210, the user may receive autosuggests 1211. The autosuggests 1211 may include spiking queries. The entities associated with the spiking queries are provided in the set of autosuggests 1211. The computer system, in one embodiment, may select autosuggests 1211 in response to a user hovering over the autosuggest to provide the details 1212. In other embodiments, the autosuggest details 1212 may provide a summary of an entity associated with the autosuggest that is the subject of the hover.

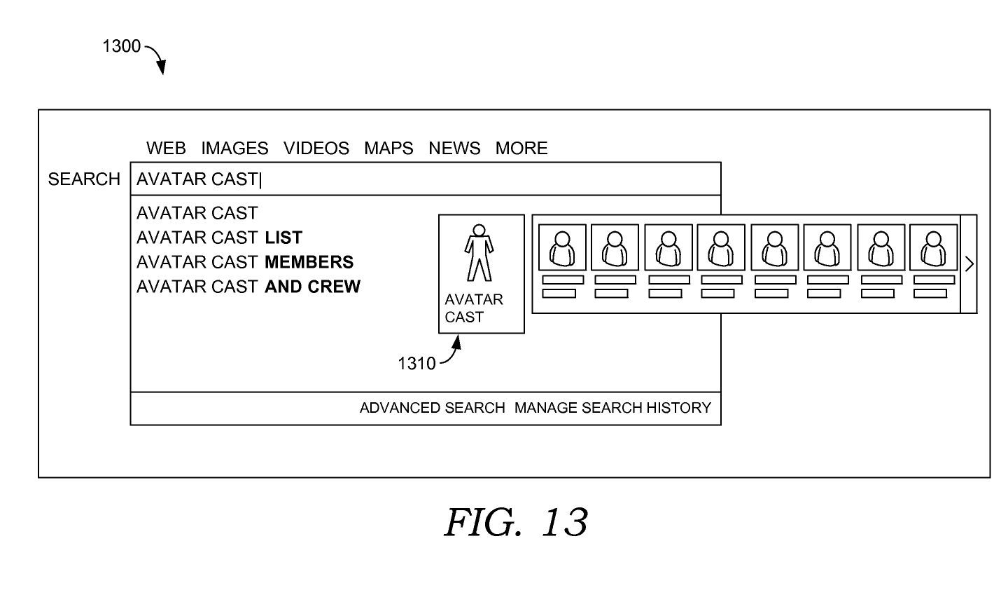

FIG. 13 is a screen shot illustrating a graphical user interface 1300 having an autosuggest with details 1310 for several entities in accordance with embodiments of the invention. As a user enters search terms AVA in a search box, the user may receive autosuggests. The autosuggests may include spiking queries. One or more entities may be extracted from the spiking queries by the computer system. In one embodiment, the extracted entities may be provided in the set of autosuggests. The computer system, in certain embodiments, may provide details 1310 for entities that correspond to the autosuggests. In other embodiments, the autosuggest details 1310 include a scrolling list of entities that corresponds to the autosuggests. The scrolling list may be shown in a single row adjacent to text representing one or more autosuggests.

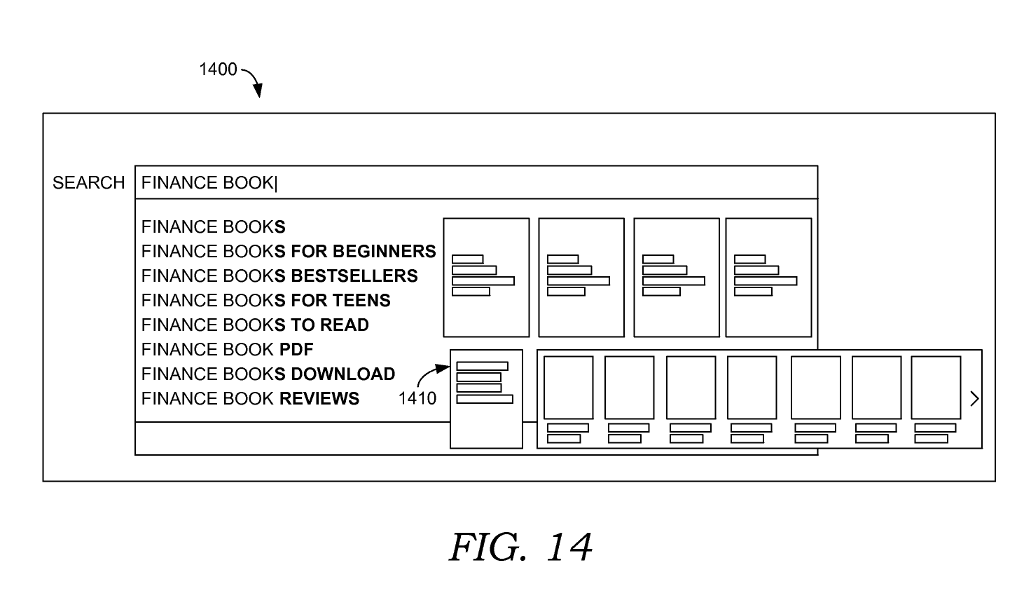

FIG. 14 is a screen shot illustrating a graphical user interface 1400 having an autosuggest with an alternative layout for details 1410 of several entities in accordance with embodiments of the invention. As a user enters search terms FIN in a search box, the user may receive autosuggests. The autosuggests may include spiking queries. One or more entities may be extracted from the spiking queries by the computer system. In one embodiment, the extracted entities may be provided in the set of autosuggests. The computer system, in certain embodiments, may provide details 1410 for entities that correspond to the autosuggests. In other embodiments, the autosuggest details 1410 include a scrolling list of entities that corresponds to the autosuggests. The scrolling list may be shown in a two rows adjacent to text representing one or more autosuggests.

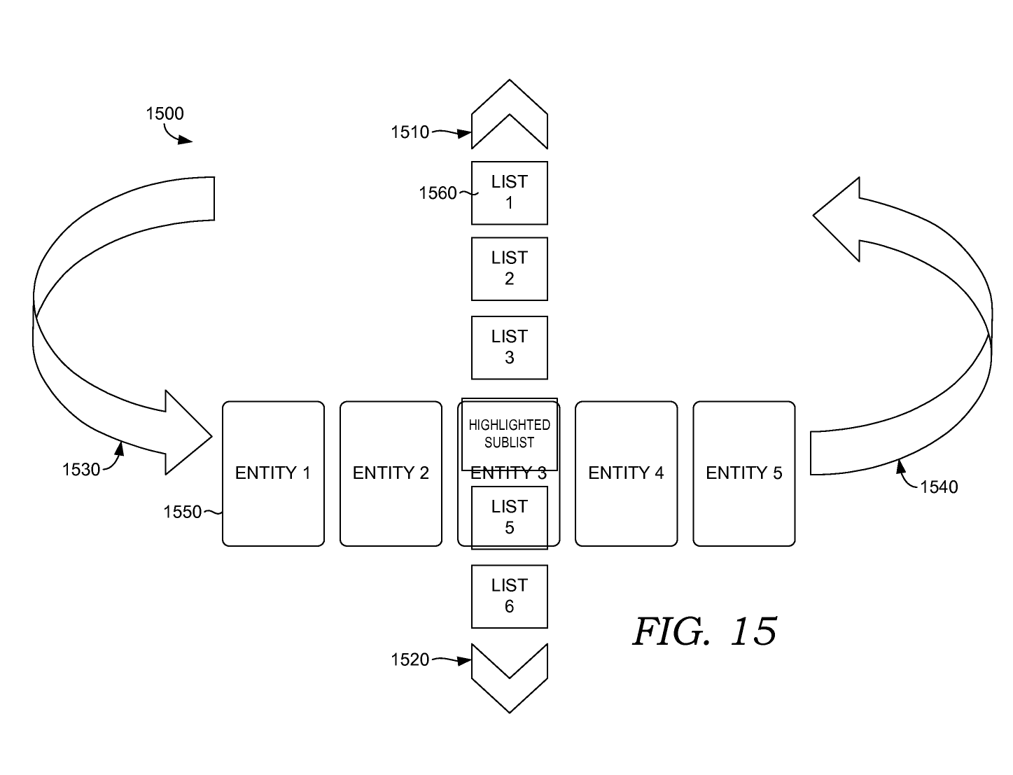

FIG. 15 is a flow diagram illustrating the potential changes in a screen's display 1500 of items representing entities 1550 in accordance with embodiments of the invention. In some embodiments, the user may interact with details of the autosuggests in at least two ways: vertically scrolling 1510 or 1520 or horizontally scrolling 1530 or 1540. Each autosuggest may be provided as a list item 1560. The list items 1560 provided by the computer system are interacted with vertically by scrolling up to view additional autosuggests with a gesture, click, and hover near or towards a scrolling region 1510. The list items 1560 are interacted with vertically by scrolling down to view previous autosuggests with a gesture, click, and hover near or towards a scrolling region 1520. In some embodiments, the list of autosuggests generated by the computer system may be an infinite scroll list that loops when it reaches the end.

In some embodiments, the list items may be presented in a stacked hierarchy. If a stack of list items is present, the graphical user interface may show a sublist indicator. When the list items do not include a stack, the sublist indicator is not shown on the graphical user interface. The sublist means that given a query, there is a list of autosuggests associated with it and these autosuggests can be further drilled down to a number of sublists. These sublists may not be further drilled down. For this scenario, after the search engine returns the sublists, the sub-lists of autosuggests may be displayed in a vertical style which can be swiped with a finger, and the autosuggests at the top of the list are more relevant or popular to the query. After user drill down by selecting and holding on a sublist icon, the autosuggest and corresponding entities of the sublist are displayed. In other embodiments of the invention, the sublist may have sublists. One of more of these sub-lists can be further drilled down to a number of lists, and so on and so forth, until there are no more drill down lists available. After the search engine returns the sub-lists, these sublists may be displayed in a vertical style and may be swiped with a finger.

As the user interacts with different autosuggests, the corresponding set of entities 1550 is updated to reflect the change. The computer system, in response to scrolling up the list of autosuggests 1560, may update the set of entities 1560. Similarly, the computer system, in response to scrolling down the list of autosuggests 1560, may update the set of entities 1550. The set of entities 1550 are interacted with horizontally by scrolling right to view additional entities 1550 in the set of entities 1550 with a gesture, click, and hover near or towards a scrolling region 1540. The most front entity at the initial phase has the highest relevance to the query. In some embodiments, additional entities may be browsed by a swipe on a touch screen from right to left. The set of entities 1550 are interacted with horizontally by scrolling left to view previous entities 1550 in the set of entities 1550 with a gesture, click, and hover near or towards a scrolling region 1530. In some embodiments, the set of entities generated by the computer system may be an infinite scroll list that loops when it reaches the end.

In summary, the embodiments of the invention detect shifted intents for queries and topics. The computer system may check for shifting intents for queries or topics that are identified as spiking or trending. For example, the following table illustrates a comparison between old query entity intent and new entity intent with temporal context awareness as provided by the computer system configured in accordance with embodiments of the invention

| Query | Old Intent | New Intent | Description |
|---|---|---|---|
| Indianapolis 500 | 2013 | 2014 | 2014 event happened |
| | Indianapolis | Indianapolis | and the query entity |
| | 500 | 500 | intent is updated to |
| | | | new entity instead of |
| | | | 2013 version |
| Katy Perry Roar | Not Available | Katy Perry | No prior intent |
| | | Roar Song | available as it is a |
| | | | new song released by |
| | | | Katy Perry. |
| | | | Alternatively, prior |
| | | | intent may be |
| | | | associated with a |
| | | | lion, tiger, bear, or |
| | | | other jungle animal |
| SIGIR | SIGIR 2013 | SIGIR 2014 | SIGIR 2014 call for |
| | | | paper is already |
| | | | announced intent |
| | | | updated from 2013 |
| | | | conference |

Accordingly, embodiments of the invention provide the freshest intent processing available to the computer system. The identification of spiking and trending queries by the computer system provides an important clue in assessing whether intent has changed for the corresponding query. The computer system provides several interactive user interfaces that allow a searcher to be informed of the spiking queries and the change intents prior to issuing a query.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A computer-implemented method for detecting intent shifts for queries, the method comprising:
determining whether a query is trending or spiking;
when the query is trending, confirming a mapping between an entity represented by the query and uniform resource identifiers (URIs) from query search results accessed by a client device that issued the trending query; and
when the query is spiking, including the query in an autosuggest area provided by the search engine in response to search terms entered at the client device.

2. The method of claim 1, wherein the query is trending when a search log maintained by the search engine has an increased volume for the query over a period of at least 4 hours.

3. The method of claim 1, wherein the query is spiking when the search volume increases significantly over a window of between 30 minutes and 3 hours.

4. The method of claim 1, further comprising: identifying an intent shift for the query based on changes in URI access or click-through information for the query.

5. The method of claim 1, further comprising: determining whether accessed URIs of the results for the spiking query are linked to an entity different from an entity stored in a search log for the search engine.

6. A computer system for providing entity information in a search box, the system comprising:
a search engine to receive search terms and to return an autosuggest having one more entities in a search box provided to a client device;
one or more entity databases storing entity and uniform resource identifier (URI) mappings;
one or more search logs storing queries executed by the search engine; and
one or more servers configured to execute the following:
a fresh intent detector to receive a merged data set having the entity mappings and search logs, identify shifts in intent for recurring queries in the search logs, identify intents for new queries in the search logs, and update mappings between an entity and a query based on the identified shifts in intent,
a filter component to receive the updated mappings between queries and entities, wherein the filter keeps queries corresponding to spiking and trending entities and removes the remaining queries, and
a rendering component to include the filtered mappings for the entities and queries in the autosuggest area of the search box provided by the search engine.

7. The system of claim 6, wherein the autosuggest area is updated with a list of previewable entity suggestions that may be scrolled through vertically or horizontally within the autosuggest area.

8. The system of claim 6, wherein entities are identified from news stories or social media blogs.

9. The system of claim 7, wherein the suggestions are scrolled through in response to gesture.

10. The system of claim 7, wherein the suggestions are scrolled through in response to touch.

11. The system of claim 6, wherein the queries are identified as spiking based on a volume increase within a short period of time.

12. The system of claim 6, wherein queries are identified as trending based on a sustained volume increase over a long period of time.

13. The system of claim 7, wherein the autosuggests include multimedia content and visual representations for the entities associated with the queries.

14. The system of claim 6, wherein the filter component may identify one or more entities for the queries based on the date.

15. The system of claim 14, wherein the queries are seasonal queries that map to different entities based on the time of year.

16. One or more computer-readable storage media storing computer-useable instructions that, when used by one or more computing devices, cause the one or more computing devices to perform a method for detecting intent shifts for queries, the method comprising:
determining whether a query is trending or spiking;
when the query is trending, confirming a mapping between an entity represented by the query and uniform resource identifiers (URIs) from query search results accessed by a client device that issued the trending query; and
when the query is spiking, including the query in an autosuggest area provided by the search engine in response to search terms entered at the client device.

17. The one or more computer-readable storage media of claim 1, wherein the query is trending when a search log maintained by the search engine has an increased volume for the query over a period of at least 4 hours.

18. The one or more computer-readable storage media of claim 1, wherein the query is spiking when the search volume increases significantly over a window of between 30 minutes and 3 hours.

19. The one or more computer-readable storage media of claim 1, further comprising identifying an intent shift for the query based on changes in URI access or click-through information for the query.

20. The one or more computer-readable storage media of claim 1, further comprising determining whether URIs of the results for the spiking query are linked to an entity different from the entity stored in a search log for the search engine.
